(19) United States
(12) Patent Application Publication
(10) Pub. No.: US 2026/0339268 A1
(43) Pub. Date: Oct. 29, 2026

(54) DISPLAY DEVICE FOR DISCRETE INDICATIONS

(71) Applicant: Pierre Goujon, Neuchâtel (CH)

(72) Inventor: Pierre Goujon, Neuchâtel (CH)

(21) Appl. No.: 19/122,152

(22) PCT Filed: Oct. 18, 2023
(86) PCT No.: PCT/IB2023/060532

§ 371 Date: Apr. 17, 2025

(30) Foreign Application Priority Data
Oct. 18, 2022 (CH) CH001234/2022

(51) Int. Cl. G04B 19/26; G04B 19/04; G04B 19/20

(52) U.S. Cl. CPC G04B 19/268; G04B 19/046; G04B 19/202

(57) ABSTRACT

The invention relates to a device for displaying discreet indications for a timepiece, the display device comprising a dial (3) which is provided with an extended aperture (3a), a first mobile (1) and a second mobile (2) which is pivoted with reference to the dial (3). The first mobile (1) supports a first series of indications (100) which are arranged in the directions of the vertices of a star-shaped polygon. The second mobile (2) supports a plurality of revealing elements (2a, 2b). The dial is arranged to partly conceal the first and second mobiles, the extended aperture (3a) being able to show an active indication which is revealed by the vertical alignment of an indication (100) of the first mobile with a revealing element (2a, 2b) of the second mobile. The device is arranged so that the first and second mobiles (1, 2) are rotated with reference to the dial (3) at proportional and separate angular velocities.

### TECHNICAL FIELD

The present invention relates to a display device for a timepiece. More particularly, it concerns a display device for discrete indications.

### STATE OF THE ART

There are many known examples of displays showing discreet indications in watchmaking, such as calendar displays. It's also possible to display the time digitally and moon phases with a series of realistic images of the moon.

Application EP4006651 concerns a discreet moon phase display that includes two mobiles rotating at the same angular speed during a display phase and angularly shifting between two display phases under the action of a drive mechanism. This display has a number of drawbacks. In order not to show incomplete and inactive portions of moon phases, the transitions between two successive phases must take place under the dial. There is therefore a loss of information during the transition period when the display is inoperative. There is also a risk of reading error since the display, which shows a moonless night during transitions, could suggest that the phase represented is the new moon. To avoid this confusion, an odd number of images has been preferred without representation of the new moon. However, a number of images that is not a multiple of four has the further disadvantage that only one of the four characteristic phases can be represented, in this case the full moon. Representations related to the first and last quarters are displayed at times in the lunar cycle that are not at the quarter and three-quarter of the cycle as they should be. This results in a lack of accuracy of the display during these characteristic phases and a risk of disrupting the display if it is used as a reference for adjustment. Furthermore, the drive mechanisms described exhibit a significant and punctual torque draw at the time of transitions. This significant torque variation is detrimental because it can cause the movement to stop in the event of joint actuation of other complications and requires an increase in motor torque at the expense of the power reserve. The drive mechanism is in itself complex and bulky and has a negative impact on the cost, size, and reliability of the movement. Furthermore, the arrangement of the indications to be displayed on a circle requires a compromise between the size of the indications and their number; in other words, between their readability and their accuracy.

Furthermore, the watchmaking industry is striving to develop a new type of continuous-motion oscillators, such as the two-degree-of-freedom oscillators described in applications EP3054357 or EP3719584. Unlike lever or detent escapements, which require a significant motor torque to ensure rapid restart of the gear train at each oscillation or alternation, continuous-motion oscillators regulate the forward movement of the gear train at a constant speed and operate with a reduced motor torque in order to prioritize the power reserve. Consequently, these oscillators are not suitable for driving complications or displays exhibiting variable torque draws.

Regardless of the type of oscillator, it would be advantageous to have a display mechanism for discreet indications exhibiting a low and constant torque draw, a reduced size, as well as high reliability and ease of manufacturing.

The objective of the invention is to overcome the various drawbacks of the discreet indication display mechanisms of the prior art.

### INVENTION DISCLOSURE

The object of the invention is achieved by a display device comprising a dial provided with an extended aperture, a first mobile pivoted with reference to the dial and carrying a first series of indications arranged according to the directions of the vertices of a star polygon, a second mobile pivoted with reference to the dial and carrying a plurality of revealers. The dial is arranged to partially mask the first and second mobiles, the extended aperture being capable of revealing an indication revealed by the superposition of an indication of the first mobile with a revealer of the second mobile.

In an original manner, the device is arranged to rotate the first and second mobiles with reference to the dial at proportional and distinct angular speeds.

This arrangement makes it possible to create a display of discreet indications with great economy of means and space while presenting a constant and low drag torque.

According to an advantageous aspect, the first and second mobiles are not coaxial, the center of the mobile with the highest angular speed preferably being located between the center of the extended aperture and the center of the mobile with the slowest angular speed. This arrangement allows an indication and a revealer to have close tangential speeds in the display area delimited by the extended aperture in order to reduce the angular width of the clearance areas between the indications and thus increase the size of the indications.

According to an advantageous aspect, the first mobile carries at least two series of indications arranged according to concentric circles, and the second mobile carries at least two series of at least one revealer, each revealer in a series being intended to reveal the indications of the corresponding series of indications.

This arrangement makes it possible, without complicating the display mechanism, to increase the surface area dedicated to the indications and to improve the ratio between the total surface area of the indications and the total surface area of the display by reducing the surface area occupied by the clearance zones separating two adjacent indications.

According to an advantageous aspect, the indications represent moon phases, and the lower edge of the extended aperture symbolizes the horizon.

This arrangement allows for a dynamic and realistic representation of the phases of the moon.

### BRIEF DESCRIPTION OF THE DRAWINGS

Other details of the invention will become clearer upon reading the following description, made with reference to the appended drawings in which:

FIGS. 1 to 6 represent the main components of a first variant of an hour display according to a first embodiment of the invention,

FIGS. 7 and 8 represent a second variant of a minute display according to a first embodiment of the invention,

FIGS. 9 to 12 represent a third variant of a moon phase display according to a first embodiment of the invention,

FIGS. 13 and 14 schematically represent a display comprising 16 indications respectively according to the first and a second embodiment of the invention,

FIGS. 15 to 18 represent a moon phase display according to the second embodiment of the invention,

FIG. 19 schematically represents a display comprising 12 indications according to the second embodiment of the invention.

### EMBODIMENTS OF THE INVENTION

There are many known examples of displaying discreet information in watchmaking, consisting of displaying a series of indications periodically. Calendar displays are the most common, but different information can be displayed in this way, such as digital time displays or moon phase displays. The indications are generally arranged in a circular manner on a disk or a ring, as is also the case for the present invention. Other indication supports are possible, such as rollers, movable flaps, or bands, but their vertical bulk limits their use for wristwatches.

The discreet display according to the invention comprises a first mobile 1 carrying a first series of indications 100, a second mobile 2 carrying at least two revealers 2a, 2b, and a dial 3 provided with an extended aperture 3a in which successively appear the active indications revealed by the superposition of an indication of the first mobile 1 with a revealer of the second mobile 2. The first and second mobiles 1, 2 are pivoted with reference to the dial 3. In the examples presented, the dial 3 is fixed with respect to the frame of the timepiece. It is entirely possible, without departing from the scope of the invention defined by the main claim, that in the frame of reference of the timepiece frame, one of the mobiles is fixed while being pivoted with reference to the dial, which itself would be mobile in rotation in the frame of reference of the frame.

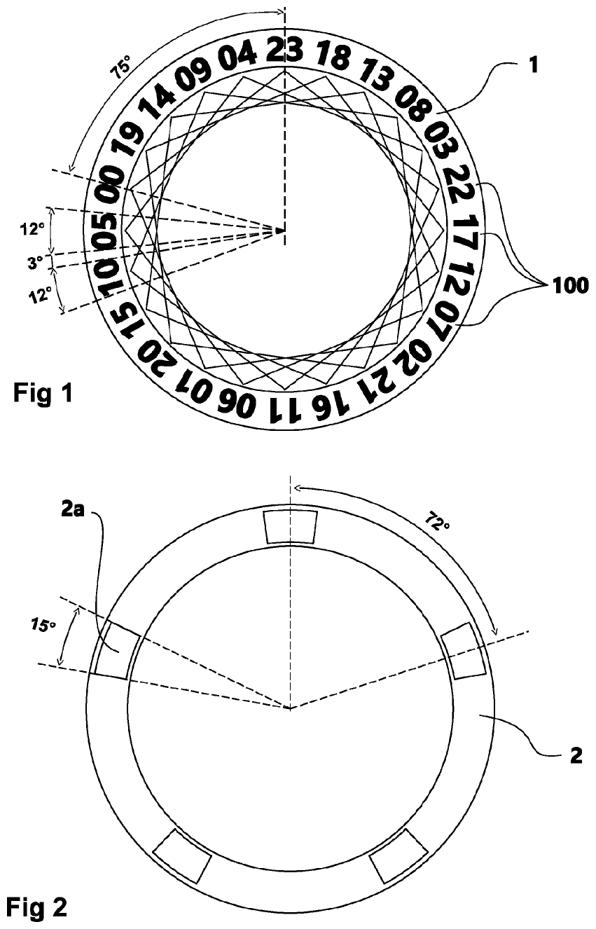

FIGS. 1 to 6 illustrate a first variant of a discreet hour display according to a first embodiment of the invention. FIG. 1 represents a first mobile 1 in the form of an annular disk intended to be pivoted with reference to a dial 3 of the timepiece. A first series of indications 100 representing the hours from zero to twenty-three is carried on the first mobile 1. The twenty-four indications are arranged in a circle according to the directions of the vertices of a regular star polygon {24/5} centered inside the first mobile 1 as represented in FIG. 1. This arrangement makes it possible to move from one indication to the next cyclically, with a constant angular offset. To form a star polygon of type {n/p} where n is the number of indications and p is the step between two successive indications, the step p must be chosen so that n and p do not have a common prime factor. For a display comprising twenty-four indications, it is possible to arrange them according to the directions of the vertices of the star polygons {24/5}, {24/7}, and {24/11}. It will be understood later why the {24/5} arrangement is the most favorable. Two adjacent indications and two successive indications in the display order are respectively separated by an angle of

$$\frac{360 °}{n}$$

and an angle of

$$\frac{p \cdot 360 °}{n} ,$$

respectively 15° and 75° for a display of type {24/5} as presented in FIGS. 1 to 6.

The display device also comprises a second mobile 2 coaxial with the first mobile 1 and carrying a number r of revealers 2a greater than or equal to two. A revealer 2a is intended to reveal the indication with which it is superimposed during the display phase where this indication is active. The revealers are distributed angularly in a regular fashion with an angular spacing of

$$\frac{360 °}{r}$$

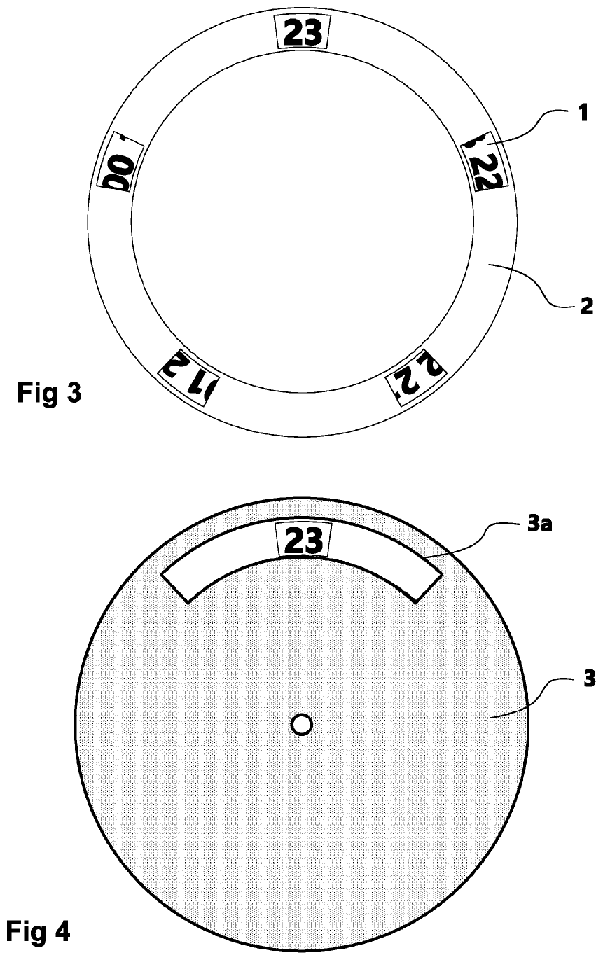

between them, that is 180° for r=2, 120° for r=3, 90° for r=4, 72° for r=5, 60° for r=6, 51° for r=7, 45° for r=8, 40° for r=9 and so on. The number of revealers is generally chosen so that the angular spacing between two revealers is as close as possible to the angular spacing between two successive indications. For a display of type {24/5}, the successive indications are separated by 75°, a value close to the 72° separating two revealers of a second mobile 2 comprising five revealers 2a as represented in FIG. 2. FIG. 3 represents the superposition of the first and second mobiles 1, 2 in their position represented in FIGS. 1 and 2.

The display device further comprises a dial 3 as represented in FIG. 4. The dial 3 is provided with an extended aperture 3a through which a portion of the first or second mobiles is visible, making it possible to view the active indication which is both in the field of the extended aperture 3a and superimposed on a revealer 2a. Conversely, the function of the dial 3 is to conceal most of the first and second mobiles when the revealers gradually shift from one indication to another. The extended aperture is not necessarily a closed aperture cut inside the dial; it can also be a missing part of the dial.

In document EP4006651, the mobiles carrying the indications and the revealers are driven at the same angular speed during the display phase of an indication, and a drive mechanism causes an instantaneous angular shift of the two mobiles between two display phases. In the present invention, the angular shift of the mobiles takes place continuously, the first and second mobiles being intended to be driven in rotation at distinct angular speeds, including during the indication display phases. Due to the difference in angular speed of the two mobiles, the revealers 2a have a greater angular width than the indications 100 so that the active indication always remains fully superimposed on a revealer when it travels through the extended aperture 3a. When it moves in the field of the extended aperture 3a, a revealer must also not come into superposition with an adjacent indication of the active indication and thus partially reveal it. It is therefore necessary to provide sufficient clearance areas between the indications. The angular width of the clearance areas corresponds to the angular offset between the two mobiles during the passage through the extended aperture.

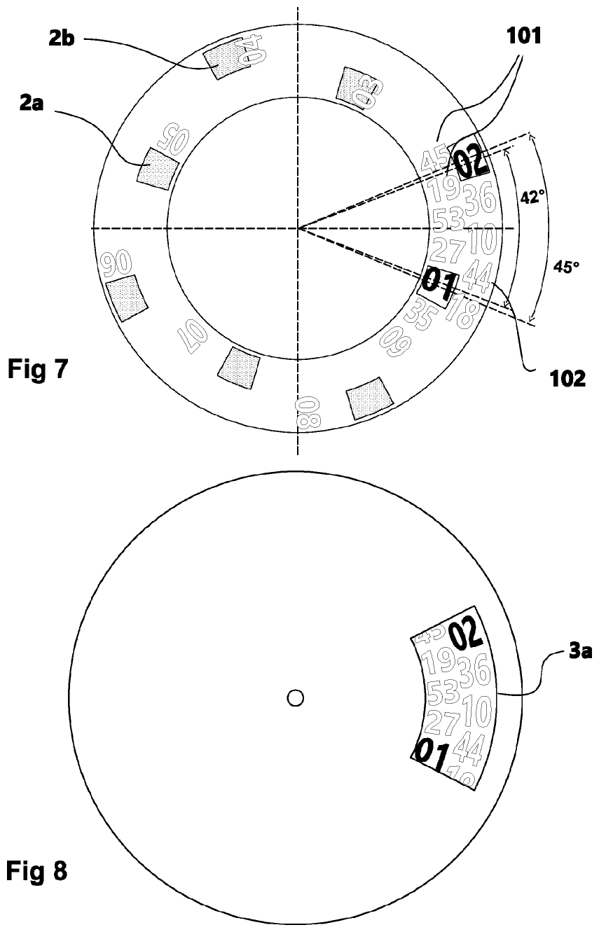

Depending on the case, the second mobile pivots at a higher or lower speed than the first mobile. In all cases, the active indication is preferably located in the center of the revealer when it is displayed in the center of the extended aperture. In the examples presented, the centering of the indication of the revealer and the extended aperture is done in the 12 o'clock position, with the exception of the example presented in FIGS. 7 and 8, where it is done in the 3 o'clock position. All indications are successively centered with a revealer when arriving at the center of the extended aperture. In other words, when the first mobile pivots by an angle of p.360°/n to move from one indication to the next, the second mobile pivots by an angle of 360°/r to move from one revealer to the next. The absolute value of the difference between these two angles substantially corresponds to the angular width of the clearance area to be provided, insofar as the width of the extended aperture substantially corresponds to the angular spacing between two successive indications. The width of the aperture can be slightly reduced so that never more than one indication is visible or, on the contrary, slightly widened to avoid a loss of information during transitions from one indication to the next. From this, we deduce the width available for each indication, which is 360/n minus the angular width of clearance.

If ω1 and ω2 are the respective angular speeds of the first and second mobiles 1, 2, the period T of display of an indication is:

$$T = \frac{p \cdot 360 °}{n \cdot ω1} = \frac{360 °}{r \cdot ω2}$$

From this, we deduce the speed ratio between the two mobiles:

$$ω1 = \frac{r \cdot p}{n} ω2$$

Since the integers n and p do not have common prime factors, the ratio r·p/n is different from 1, that is to say that the first and second mobiles are intended to be driven at proportional and distinct speeds.

In the examples presented in FIGS. 1 to 6 and 9 to 12, the successive indications are separated by 75° and the revealers by 72°. It is therefore necessary to provide a clearance area of approximately 3° between the indications, which corresponds to the angular offset of the two mobiles during the display time T of an indication. The remaining available width for the indications is therefore approximately 12° for a display of type {24/5}. Optimally, the revealers 2a have an angular width of 360/n, or 15°, in the examples of display {24/5} presented.

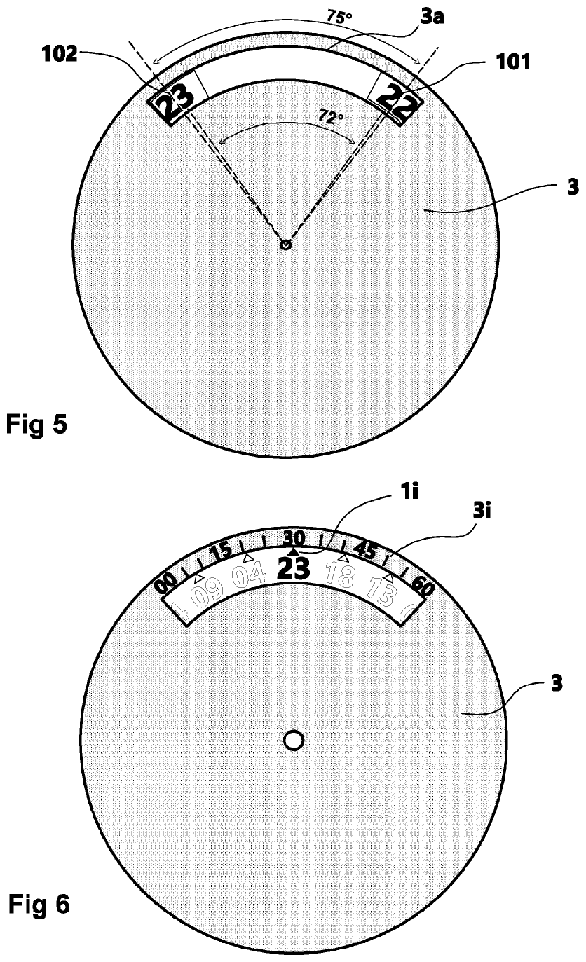

FIG. 5 represents a discreet display of the time at the moment of transition from one indication to the next. The extended aperture 3a is slightly wider than the 75° gap between two successive indications 101, 102 so that it is possible to see two successive indications at the moment of transition. With reference to FIG. 5, the current time indication appears on the left of the extended aperture and disappears on the right, the first and second mobiles being intended to be driven in rotation in the clockwise direction, at respective angular speeds distinct from 75°/h and 72°/h.

When an indication is a time quantity, its position during a display phase makes it possible to obtain information on a fraction of this time quantity. Thus, if the indication is the month of the year, the position of the displayed month can give the information of the day of the month. Similarly, the position of the day of the month indication can give the time of day, or the minute information can indicate the second. In the example of a discreet time display represented in FIG. 6, the position of the time displayed in the extended aperture 3a gives the information of the number of minutes elapsed in the current hour. To facilitate the reading of this information, the first mobile 1 and the dial 3 respectively comprise indicators 1i and an indication scale 3i. The indicators could also be placed on the second mobile 1 at the level of each of the revealers 2a.

The variants presented in FIGS. 1 to 5 present a first type of revealers. The revealers 2a here take the form of windows formed in the second mobile 2. The second mobile is positioned between the first mobile and the dial so that it masks the indications which are in the field of the extended aperture 3a, with the exception of the active indication which remains visible inside a window during the entirety of its movement in the extended aperture. Preferably, the background color of the second mobile is identical to that of the first mobile so that the edges of the window-shaped revealer are difficult to detect. The windows can just as easily be hollowed-out areas of the second mobile as translucent areas allowing the indications to be seen through transparency.

The examples in FIGS. 6 to 12 and 15 to 18 present a second type of revealers in which the indications 100 take the form of profiles formed on the first mobile. In the same way as for the revealers of the first type, the profiles can be cutouts in the first mobile or translucent areas. In the second type of revealers, the second mobile comprises a background of the same appearance as the background of the first mobile and contrasting areas which constitute the revealers 2a. For this second type of revealer, the first mobile 1 is placed between the second mobile 2 and the dial 3. Even if several indications are in the field of the extended aperture 3a, only the active indication(s) are revealed by being superimposed on a contrasting area of the second mobile. The inactive indications are camouflaged because they have the same appearance as the background of the first mobile.

The term revealer used throughout the application refers interchangeably to the first or second type of revealers. The two types of revealers are equivalent.

FIGS. 7 and 8 represent a second variant of a discreet minute display according to the first embodiment of the invention. It would be possible to arrange the sixty minute indications on a circle as in the first variant, according to the directions of the vertices of a star polygon {60/7}. The gaps between two adjacent and successive indications would be 6° and 42° respectively, and the choice of a second mobile with nine revealers spaced 40° apart would lead to a clearance area of 2°. The angular width of the indications would therefore be limited to 4°, which would make reading very difficult. By comparison, the angular width of the indications of a calendar disc is approximately 10°. To remedy this problem of indication size, discreet minute displays of the prior art are content to display the minutes in increments of five or resort to complex mechanisms comprising two mobiles, one for the units, the other for the tens. The present invention makes it possible to solve this problem without additional complication by distributing the indications according to several series arranged on concentric circles of distinct radii. To each series of indications 101, 102 corresponds a series of at least one revealer 2a, 2b intended to reveal the indications of a series of indications.

FIG. 7 schematically represents the superposition of a first and a second mobile. Minute indications are partially represented and are divided into two series of thirty indications each, the odd minutes being arranged on an inner circle and the even minutes on an outer circle. Even if they are placed on circles of different radii, the indications remain ordered according to the directions of the vertices of a star polygon {60/7}, two successive indications being separated by 42°. It is not possible to use a second mobile with nine revealers spaced 40° apart because the number of revealers must be a multiple of the number of series of indications. In the example presented, we choose a second mobile comprising two series of four revealers, two successive revealers being offset radially and spaced angularly by 45° as represented in FIG. 7. The first and second mobiles are therefore driven at respective speeds of 42°/min and 45°/min. The width of the clearance area is approximately 3°, but since the angular spacing between two adjacent indications is 12°, the angular width available for the indications is approximately 9°, which is more than double the size obtained for an arrangement on a single circle. In the case of a distribution in three series of twenty indications with three series of three revealers spaced 40° apart, the clearance area is only 2° and the width of the indications is 16°.

The width of the clearance area does not increase with the number of series, so that a distribution of the indications in several series not only makes it possible to proportionally increase the surface area of the display but also to increase the useful portion of this area reserved for the indications. Some configurations that are not feasible in a single series become so if the indications are distributed in several series. For example, a {12/5} display in a single series is not possible, whereas it is if the indications are arranged in two series of six.

FIG. 8 represents a display of the minutes appearing in an extended aperture centered at 3 o'clock, at the moment of transition between the first and second minute. It would also be possible to provide a scale indicating the seconds and indicators integral with one of the two mobiles.

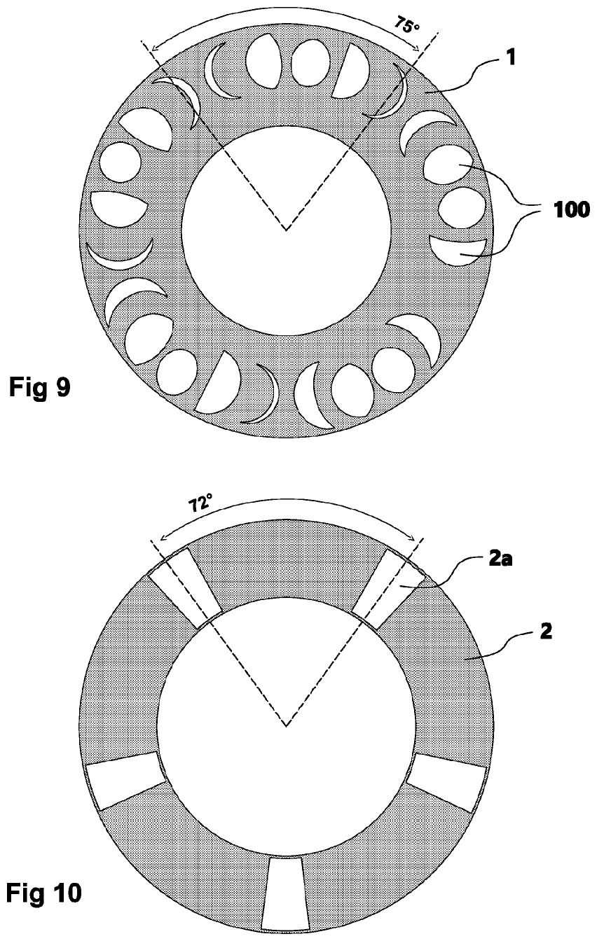

FIGS. 9 to 12 represent a discreet moon phase display according to a first embodiment of the invention. FIG. 9 represents a first mobile 1 comprising twenty-four indications 100 representing twenty-four phases of the moon in the form of cut profiles. No cutout appears at the location corresponding to the new moon. The indications are arranged according to a polygon {24/5} as for the first variant of discreet time indication.

FIG. 10 represents the second mobile 2 fitted with five revealers 2a in the form of contrasting areas representing the surface of the moon. The backgrounds of the first and second mobiles have the same appearance and represent a night sky.

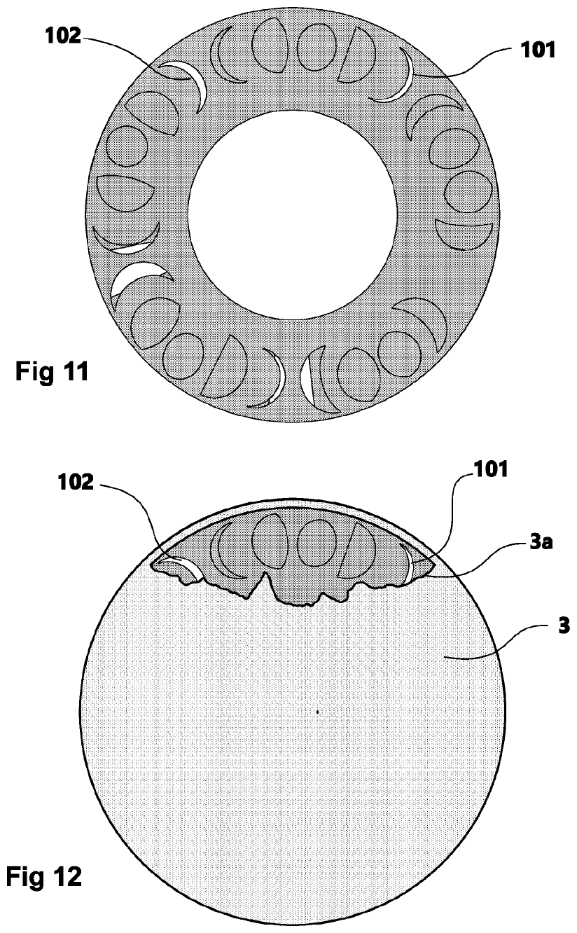

FIG. 11 represents the first and second mobiles 1, 2 superimposed in the same position as in the previous figures. The revealer under the location of the new moon is not visible.

FIG. 12 represents a dial 3 fitted with an extended aperture 3a in which the first and second mobiles 1, 2 are visible, always in the same position. The extended aperture represents a portion of sky and its lower edge a horizon line. The moon images rise on the left of the extended aperture, describe a portion of a circular trajectory, and set on the right of the aperture. This arrangement makes it possible not to have a loss of information during the transition from one indication to the next. It is also possible to reduce the size of the extended aperture to see only one moon in the sky.

The most common moon displays of the prior art comprise a disc carrying two moons, driven at a speed of one half turn per lunation. In its most ordinary embodiment, the moon disc is fitted with a 59-tooth wheel driven by one tooth per day, making it easy to achieve a display period of 29.5 days. Since the duration of a synodic revolution of the moon is 29 days, 12 hours, 44 minutes and 2.8 seconds, these displays need to be corrected regularly. To remedy this, some more sophisticated movements have a so-called “astronomical” moon display in which the moon disc is fitted with a 135-tooth wheel driven by a 16-tooth wheel mounted on a 7-branch star driven by a twenty-four hour wheel. The display period thus obtained is 29 days, 12 hours and 45 minutes, generating an offset of only one day in 122 years. However, the realization of a 135-tooth wheel is not an easy task and this type of display remains rare

The discreet moon phase display according to the invention, in which the first mobile carrying the moon images is driven at a constant speed, makes it easier to produce an astronomical moon display. The angular spacing between two successive indications p360°/n also corresponds to the angular amplitude of the displacement of an active indication. For n indications, the total angular displacement during a display cycle is p360°, in other words the first mobile makes a number of turns equal to p during a display cycle corresponding to a lunation. Therefore, it is easy to choose a number p divisor of 135 (p=3, p=5, p=9 or p=15) to produce an astronomical moon display by replacing the 135-tooth wheel with a 135/p tooth wheel that is easier to produce. To obtain a continuous drive for the first wheel, the traditional seven-pointed star of the intermediate wheel carrying the 16-tooth wheel is also replaced by a 10/35 reduction gear from the twenty-four-hour wheel or 10/70 from the twelve-hour wheel.

The first and second wheels 1, 2 are kinematically connected to the movement of a timepiece by drive means not shown, for example a wheel fitted with two meshing pinions with teeth integral with the first and second wheels. The different gear ratios between the input mobile and the first and second mobiles enable the first and second mobiles 1, 2 to be driven at constantly distinct angular speeds with reference to the dial 3. This makes it possible to design a simple display mechanism for discrete indications with constant and virtually zero torque input.

The table below gives the characteristics of a display having a number n of indications and an extended aperture of angular width Ls. La, Ls and Lr are respectively the angular widths between two adjacent indications, between two successive indications, and between two revealers, Ld and Li are the angular widths of the clearance area and of the indications. The number of revealers r is preferably chosen as the integer closest to the ratio n/p. The ratio Li/La gives the proportion of the surface of the first mobile occupied by the indications, the complement being reserved for the clearance areas. The value p of the step between two successive indications is preferably chosen so that n+1 or n−1 is a multiple of p, that is to say so that a revealer shifts by only one indication in one turn. It is observed that some values of Li are zero, which means that the corresponding configurations are not feasible with this first embodiment.

| n | p | La = 360/n | Ls = 360.p/n | n/p | r | Lr = 360/r | Ld = \|Ls − Lr\| | Li = La − Ld | Li/La % |
|---|---|---|---|---|---|---|---|---|---|
| 7 | 2 | 51.4 | 102.86 | 3.5 | 4 | 90 | 12.9 | 38.6 | 75 |
| 7 | 3 | 51.4 | 154.29 | 2.3 | 2 | 180 | 25.7 | 25.7 | 50 |
| 8 | 3 | 45 | 135 | 2.7 | 3 | 120 | 15.0 | 30 | 67 |
| 12 | 5 | 30 | 150 | 2.4 | 2 | 180 | 30 | 0 | 0 |
| 2 × 6 | 5 | 60 | 150 | 2.4 | 2 | 180 | 30 | 30 | 50 |
| 16 | 3 | 22.5 | 67.5 | 5.3 | 5 | 72 | 4.5 | 18 | 80 |
| 16 | 5 | 22.5 | 112.5 | 3.2 | 3 | 120 | 7.5 | 15 | 67 |
| 16 | 7 | 22.5 | 157.5 | 2.3 | 2 | 180 | 22.5 | 0 | 0 |
| 20 | 3 | 18 | 54 | 6.7 | 7 | 51.4 | 2.6 | 15.4 | 86 |
| 20 | 7 | 18 | 126 | 2.9 | 3 | 120 | 6 | 12 | 67 |
| 20 | 9 | 18 | 162 | 2.2 | 2 | 180 | 18 | 0 | 0 |
| 24 | 5 | 15 | 75 | 4.8 | 5 | 72 | 3 | 12 | 80 |
| 24 | 7 | 15 | 105 | 3.4 | 3 | 120 | 15 | 0 | 0 |
| 24 | 11 | 15 | 165 | 2.2 | 2 | 180 | 15 | 0 | 0 |
| 28 | 3 | 12.9 | 38.6 | 9.3 | 9 | 40 | 1.4 | 11.4 | 89 |
| 28 | 5 | 12.9 | 64.3 | 5.6 | 6 | 60 | 4.3 | 8.6 | 67 |
| 28 | 9 | 12.9 | 115.7 | 3.1 | 3 | 120 | 4.3 | 8.6 | 67 |
| 31 | 2 | 11.6 | 23.2 | 15.5 | 16 | 22.5 | 0.7 | 10.9 | 94 |
| 31 | 3 | 11.6 | 34.8 | 10.3 | 10 | 36 | 1.2 | 10.5 | 90 |
| 31 | 4 | 11.6 | 46.5 | 7.7 | 8 | 45 | 1.5 | 10.2 | 88 |
| 31 | 5 | 11.6 | 58.1 | 6.2 | 6 | 60 | 1.9 | 9.7 | 83 |
| 31 | 6 | 11.6 | 69.7 | 5.2 | 5 | 72 | 2.3 | 9.3 | 80 |
| 31 | 8 | 11.6 | 92.9 | 3.9 | 4 | 90 | 2.9 | 8.7 | 75 |
| 31 | 10 | 11.6 | 116.1 | 3.1 | 3 | 120 | 3.9 | 7.7 | 67 |
| 31 | 15 | 11.6 | 174.2 | 2.1 | 2 | 180 | 5.8 | 5.8 | 50 |
| 60 | 7 | 6 | 42 | 8.6 | 9 | 40 | 2 | 4 | 67 |
| 3 × 20 | 7 | 18 | 42 | 8.6 | 9 | 40 | 2 | 16 | 89 |
| 2 × 30 | 7 | 12 | 42.0 | 8.6 | 8 | 45 | 3 | 9 | 75 |

Considering the {24/5} display of the moon phase in FIG. 12, one might wish to obtain a larger extended aperture and moon images by reducing the number of indications. Configurations {20/7} or {16/5} would allow widening the aperture, but the useful surface area of the indications would only represent two-thirds of the total display surface instead of 80% for the {24/5} display.

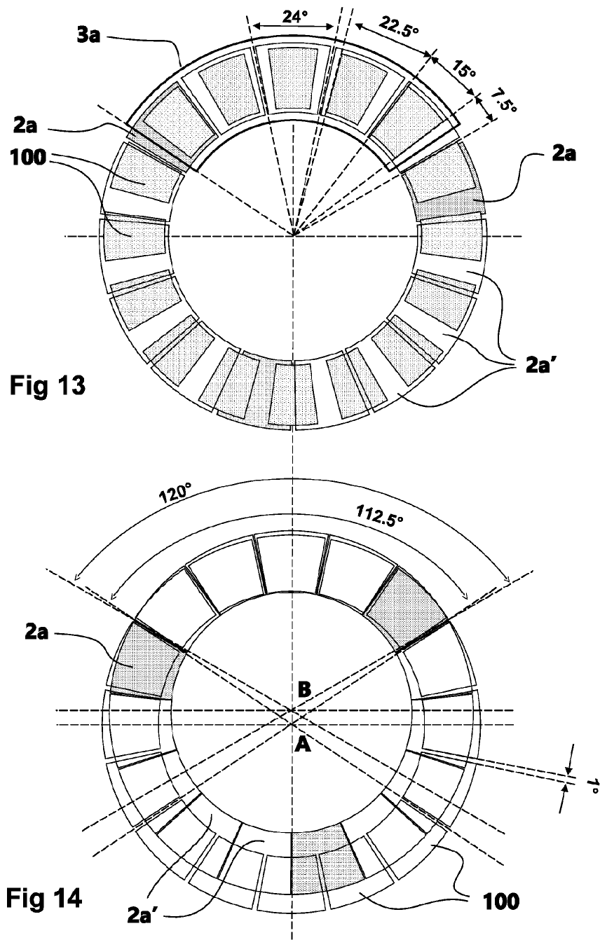

FIG. 13 schematically represents the first and second mobiles of a {16/5} display comprising three revealers 2a and for which the widths of the indications and clearance areas are 15° and 7.5° respectively. The first mobile pivots 112.5° to move from one indication to the next while the second mobile pivots 120° to move from one revealer to the next. FIG. 13 also represents the positions occupied by an indication and a revealer at regular time intervals during which the indication pivots 22.5° and the revealer 24°. The successive positions of the indication merge with those of the indications 100 which are also spaced 22.5° apart. The positions of the revealers are represented by the traces 2a′. This representation allows visualizing the progressive shift of the revealer and the indication. The indication and the revealer are centered in the 12 o'clock position, in the center of the extended aperture 3a. After fifteen time intervals, the revealer has made a complete turn, i.e. fifteen times 24°, and has shifted fifteen times 1.5° with respect to the indication, i.e. 22.5°, to find itself superimposed on the adjacent indication.

FIG. 14 schematically represents the first and second mobiles of a {16/5} display according to a second embodiment in which the two mobiles are eccentric. The extended aperture, not shown, is centered in the 12 o'clock position and has an angular width of approximately 112.5°. Like FIG. 13, FIG. 14 also represents the successive positions occupied by an indication and a revealer at regular time intervals and makes it possible to visualize their shift during a rotation of the mobiles. The eccentricity consists of moving the center of the mobile having the highest angular speed towards the center of the extended aperture, that is to say between the center of the slowest mobile and the center of the extended aperture, which has the effect that the apparent tangential speeds of the indications and revealers are close in the display area delimited by the extended aperture 3a. Conversely, the difference in apparent tangential speed is maximum in the opposite area. To remain entirely superimposed on the indications 100 in the field of the extended aperture, the revealers 2a have a greater radial dimension than the indications 100. On the other hand, the orthoradial offset is very small, and the clearance areas between the indications can be reduced to around 1°.

The eccentricity can, for example, be fixed in such a way that a point of mean radius of the indication and the point of the revealer with which it is superimposed at the entrance of the extended aperture are again superimposed at the exit of the extended aperture, the first having traveled an arc of 112.5° and the second an arc of 120°. During their displacements, the two points shift essentially radially. If Rm is the mean radius, a value of the eccentricity e can be calculated as a function of the angles Ls and Lr previously defined:

$$e = Rm \times \vert cos \frac{Ls}{2} - sin \frac{Ls}{2} \times cot g \frac{Lr}{2} \vert$$

The eccentricity also makes it possible to simplify the driving means of the mobiles insofar as teeth of different diameters of each of the mobiles can mesh with the same input pinion in an area where the projection of the primitive circles of the teeth are secant or tangent.

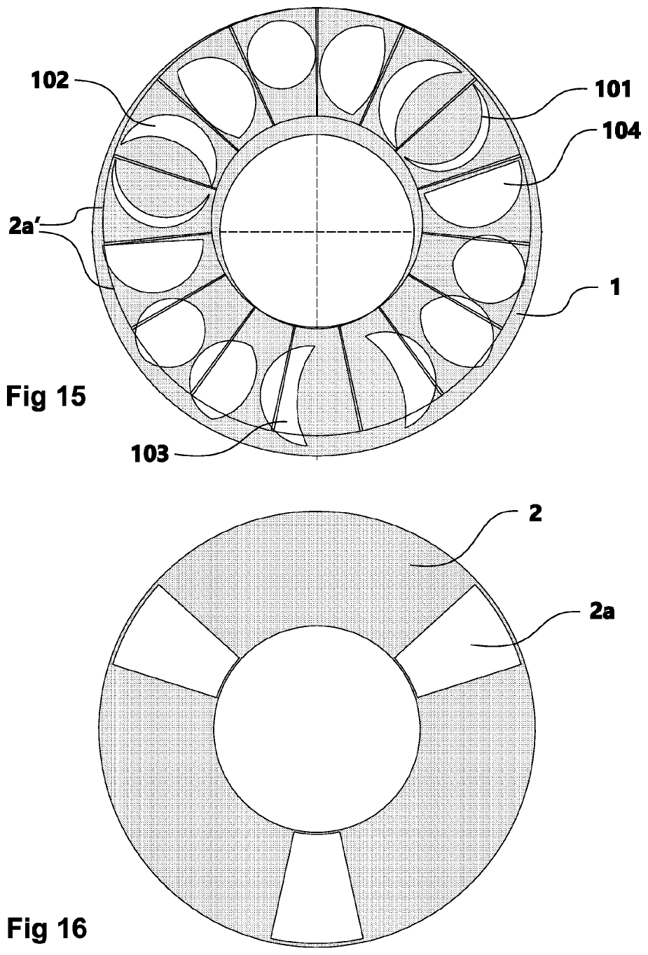

FIGS. 15 to 18 represent a moon phase display of type {16/5} according to the second embodiment of the invention. FIG. 15 represents the first mobile 1 comprising indications of the moon in the form of cut profiles as well as all fifteen positions 2a′ likely to be occupied by a revealer given the position of the first mobile 1. Thanks to the eccentricity of the second mobile, the angular width of the indications could be increased from 15° to nearly 22°.

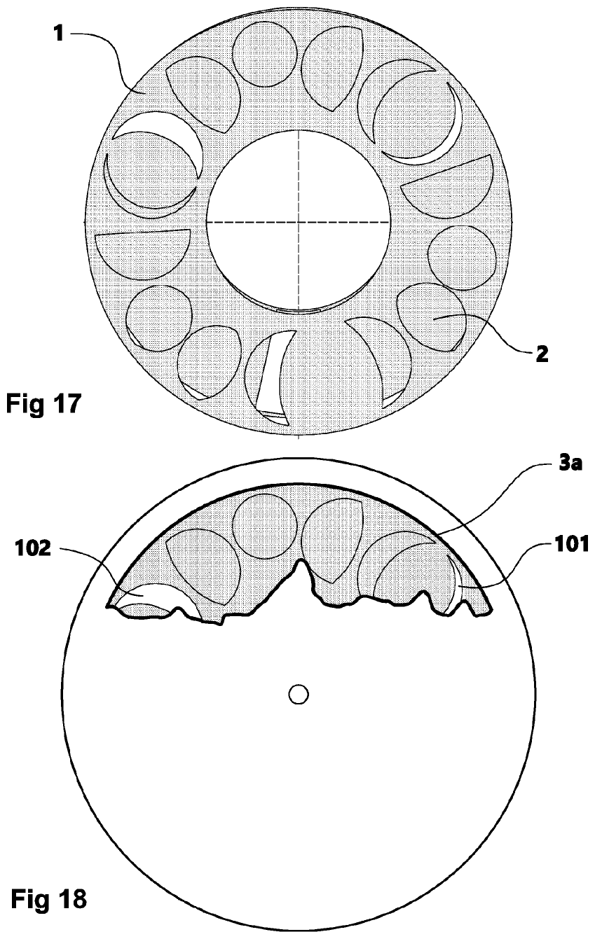

FIG. 16 represents the second mobile 2 comprising three revealers 2a. FIGS. 17 and 18 represent the two mobiles superimposed in the same position as previously, respectively without and with the dial 3. The first crescent 101 is about to disappear under the dial 3 while the second crescent 102 appears on the left of the extended aperture 3a.

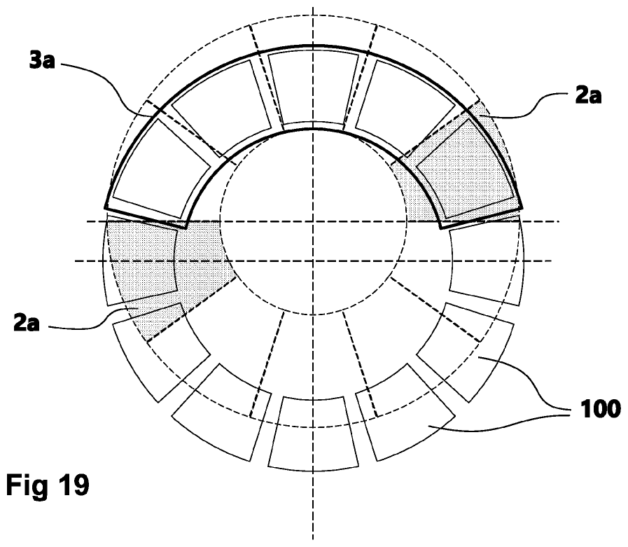

FIG. 19 represents a schematic view of a {12/5} display according to the second embodiment. We have seen that such a display could only be achieved with coaxial mobiles by distributing the indications on two series of six indications. The second mobile has two revealers 2a spaced 180° apart which are in turn superimposed, in the field of the extended aperture 3a, on successive indications of the first mobile spaced 150° apart. It can be noted that, to simplify the representation, the annular portion shape of the indications has not been optimized.

It can be noted that the dimension of the indications can vary from one series to another to optimize the total useful surface area devoted to the indications. Those skilled in the art will know how to combine the various characteristics presented in the examples of embodiments to obtain a wide variety of discreet indication displays without departing from the scope of the invention. In particular, it is possible to combine the second multi-series variant with the second embodiment where the mobiles are not coaxial.

1. Display device for discreet indications for a timepiece, the display device comprising a dial (3) provided with an extended aperture (3a), a first mobile (1) and a second mobile (2) pivoted with reference to the dial (3), the first mobile (1) carrying a first series of indications (100) arranged according to the directions of the vertices of a star polygon of type {n/p} where n is the number of indications and p is the step between two successive indications, two adjacent indications being separated by an angle of
$$\frac{360 °}{n} ,$$
and two successive indications being separated by an angle of
$$\frac{p \cdot 360 °}{n} ,$$
the second mobile (2) carrying a plurality r of revealers (2a, 2b) separated by an angle of
$$\frac{360 °}{r}$$
from each other, the dial being arranged to partially mask the first and second mobiles, the extended aperture (3a) being suitable for revealing an active indication revealed by the superposition of an indication (100) of the first mobile with a revealer (2a, 2b) of the second mobile, wherein the device comprises drive means arranged to drive in rotation the first and second mobiles (1, 2) with reference to the dial (3) at respective angular speeds ω1 and ω2, proportional and distinct according to a proportionality ratio
$$ω1 / ω2 = \frac{r \cdot p}{n} .$$

2. Device according to claim 1 wherein the second mobile (2) is intended to be placed between the first mobile and the dial and in which the revealers take the form of windows.

3. Device according to claim 1 wherein the first mobile (1) is intended to be placed between the second mobile (2) and the dial (3) and in which the indications (100) take the form of profiles formed on the first mobile (1).

4. Device according to claim 1 wherein the first and second mobiles (1, 2) are coaxial.

5. Device according to claim 1 wherein the first and second mobiles (1, 2) are not coaxial.

6. Device according to the preceding claim wherein the center of the mobile having the highest angular speed is located between the center of the extended aperture and the center of the mobile having the lowest angular speed.

7. Device according to claim 1 wherein the appearance of the background of the first mobile (1) is identical to that of the background of the second mobile (2).

8. Device according to claim 1 wherein the first mobile comprises a number n of indications and the second mobile comprises a number r of revealers chosen so that n+1 or n−1 is a multiple of r.

9. Device according to claim 1 wherein the indications represent moon phases.

10. Device according to claim 1 wherein the first mobile (1) carries at least two series of indications arranged according to concentric circles of distinct radii and in which the second mobile (2) carries at least two series of at least one revealer (2a, 2b), each series of revealers being intended to reveal the indications of a series of indications.
